(19) United States
(12) Patent Application Publication
(10) Pub. No.: US 2010/0244728 A1
(43) Pub. Date: Sep. 30, 2010

(54) METHOD AND CONTROL CIRCUIT FOR DIMMING A GAS DISCHARGE LAMP

(75) Inventor: Marcel Beij, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/743,018

(22) PCT Filed: Nov. 17, 2008
(86) PCT No.: PCT/IB08/54800

§ 371 Date: May 14, 2010

(30) Foreign Application Priority Data
Nov. 22, 2007 (EP) 07121253.4

(51) Int. Cl. H05B 41/38

(52) U.S. Cl. 315/291

(57) ABSTRACT

In a method of dimming a gas discharge lamp, a controllable switch is provided which is connected between terminals of the lamp receiving an alternating power supply voltage. The opening and closing of the switch is controlled. The switch is closed at least during a first closing time period and a subsequent second closing time period within a half period of the power supply voltage. The second closing time period is longer than the first closing time period. The switch may be closed during a plurality of closing time periods within a half period of the power supply voltage, each closing time period after the first closing time period being longer than a previous closing time period. The first closing time period is started after a delay time period after a first reignition of the lamp after a voltage zero-crossing of the power supply voltage.

### FIELD OF THE INVENTION

The present invention relates to a method for dimming a gas discharge lamp. The present invention further relates to a dimming control circuit for dimming a gas discharge lamp, the use of the dimming control circuit, and a control module comprising the dimming control circuit. The invention may be implemented in the field of fluorescent lamps and in the field of other types of gas discharge lamps.

### BACKGROUND OF THE INVENTION

With the development and proliferation of gas discharge lamps, such as fluorescent lamps, in particular but not exclusively for use in offices, public places, and at home, a very extensive installed base has come into existence. In the past, such lamps have been provided with a simple ballast including basically capacitive and inductive elements and a glowstarter to start the lamp ignition. The conventional glowstarter, comprising a starting switch, is built into a small, usually cylindrical volume, and this small-size component is provided in a luminaire at a position where a relatively easy replacement would be possible if the glowstarter would fail. The lamp starts by opening the starting switch of the glowstarter. The lamp then operates at a predetermined, maximum power level for extended periods of time. In the course of time, the light output of the lamp slowly decreases due to electrochemical processes in the lamp making the conversion of electrical energy into light less efficient. It has, therefore, been customary to determine a required number of lamps for a given lighting system application on the basis of the light output of the lamps as it would be after a long time, when the light output of the fluorescent lamps would have decreased when compared to the initial light output thereof. Accordingly, the initial light output of the lamps in a lighting system is higher than actually required, and dimming the lamps in this period of their life would still allow to produce a required amount of light for the given lighting system application.

In recent years, a need has arisen to conserve energy as much as possible. Taking into account that the conventional lighting systems comprising fluorescent lamps in fact systematically were over dimensioned, providing more light than necessary as explained above, an even more pressing interest has come up to be able to dim the lamps, i.e. reduce the light output of the lamps, at the same time reducing the consumption of electrical energy by the lamp correspondingly. The conventional lighting systems, comprising fluorescent lamps and conventional ballasts, however, did not provide a facility to dim the lamp. Accordingly, the lighting systems needed to be adapted to provide a dimming of the fluorescent lamp.

In practice, a dimming of about 20% may be acceptable on average, although in some cases a dimming of up to 30% or 40%, or no more than 10% is also possible. The percentage of dimming corresponds to a percentage of saving electrical energy, which gives a prospect of a huge potential in terms of energy saving in view of the many millions of luminescent lamps installed all over the world.

U.S. Pat. No. 4,682,083 discloses a fluorescent lamp dimming adaptor comprising a switching module adapted to be coupled in parallel to an existing conventional ballast, where the conductive state of the switching module is controlled to vary the current in the lamp by switching at a frequency in the range of 300 Hz and higher during times that the lamp current is being varied. Switching the switching module conductive results in zero current through the fluorescent lamp and zero voltage across the lamp, and during such periods the lamp will not emit light. Effectively, a dimming of the lamp is reached proportionally to the time during which the switching module is conductive.

Changing the existing, installed conventional lighting systems comprising luminescent lamps, to dimmed lighting systems requires an adaptation of each and every lighting system. The dimming adaptor according to U.S. Pat. No. 4,682,083 is designed to be used in conjunction with a conventional ballast. When an existing lighting system is to be retrofitted with such a dimming adaptor, this necessitates various disassembling and assembling operations of the lighting system, provided that sufficient space can be found for the dimming adaptor. Anyway, a relatively extensive installation effort is required. However, the sheer number of installed lighting systems would in fact necessitate that the retrofitting can be performed easily, quickly, and at a low cost, without having to disassemble the lighting system to perform the necessary work, and thereafter having to assemble the lighting system again. Also, available space for an additional component like a dimming adaptor in an existing lighting system may be very limited, or in fact not present.

Dimming systems as discussed above will produce substantial EMI (ElectroMagnetic Interference) since in the conventional dimming systems voltages with a high dV/dt (voltage gradient value, or voltage change in time) will occur, and in order to comply with requirements of EMC (ElectroMagnetic Compatibility), heavy and large EMI filters are necessary, which is in conflict with a low space requirement.

### OBJECT OF THE INVENTION

It is desirable to provide for a dimming of gas discharge lamps, in particular of fluorescent lamps, and more in particular for fluorescent lamps of existing lighting systems, at low cost. It is further desirable to provide for a dimming control circuit for gas discharge lamps, in particular for fluorescent lamps, and more in particular for fluorescent lamps of existing lighting systems, with a low EMI. It is further desirable to provide for a dimming module for gas discharge lamps, in particular fluorescent lamps, and more in particular for fluorescent lamps of existing lighting systems, with a low volume.

### SUMMARY OF THE INVENTION

In an embodiment, the method of dimming a gas discharge lamp according to the present invention comprises: providing a controllable switch which is configured to be connected between terminals of the lamp receiving an alternating power supply voltage, and controlling the opening and closing of the switch, the switch being closed at least during a first closing time period and a subsequent second closing time period within a half period of the power supply voltage, wherein the second closing time period is longer than the first closing time period. Contrary to the prior art, disclosing closing time periods of equal length leading to high reignition voltages within a half period of the mains supply voltage, the present invention proposes to increase the closing time period from a first closing time period to a following closing time period. In this way, the first closing time period can be kept relatively short, and the following closing time period(s) can be kept longer, thus reducing the EMI produced by having a low dV/dt of the voltage produced. Since the EMI produced is relatively low, no voluminous filters are necessary, thus keeping the volume of a dimming control circuit implementing the method low.

In an embodiment, the switch is closed during a plurality of closing time periods within a half period of the power supply voltage, each closing time period after the first closing time period being longer than a previous closing time period, providing both an excellent dimming performance and a low EMI. The number of closing time periods and their duration is chosen such that a particular amount of dimming is realized. Further, their duration is chosen such that they will produce light fluctuations that are invisible for the human eye.

In an embodiment, the first closing time period is started after a delay time period after a first reignition of the lamp after a voltage zero-crossing of the power supply voltage. In a gas discharge lamp, after a voltage zero-crossing of the power supply voltage, the plasma enabling a current to flow will need some time to become stable. Providing this time as the delay time will prevent excessive EMI in the method of the invention, and provide a stable functioning of a dimming control circuit implementing the method. In an embodiment, the delay time period is at least 20% of the half period of the power supply voltage. In a further embodiment, the delay time period is at least 2 ms, e.g. about 5 ms in a 50 Hz mains power supply system.

In an embodiment, the length of the closing time periods in a half period of the power supply voltage is decreased over time. This time, counted in units from hours to years, may be the expected life time of the lamp. Not taking into account lamp dimming, the light output of the lamp decreases over time. If the light output of the lamp at the start of use is taken as a first reference value, and the light output of the lamp at the end of its expected life time is taken as a second reference value, then a dimming of the lamp may be varied over time in various ways. As an example, the dimming of the lamp at the end of its expected life time may be at a minimum (no or low dimming) such that the lamp has a light output equal to the second reference value, while the dimming of the lamp at the start of use may be at a maximum (high dimming) such that the lamp does not have a light output equal to the first reference value, but has a light output substantially equal to the second reference value, while during the life time of the lamp the dimming is reduced from the high dimming to the low dimming, so that the lamp always essentially produces the same amount of light. The amount of dimming of the lamp may follow the light output variation (not taking into account the dimming) of the lamp over time. The light output variation may be essentially linearly decreasing over operating hours of the lamp, or may decrease non-linearly.

In an embodiment, the invention provides a dimming control circuit for performing a dimming method for a gas discharge lamp according to the invention. The dimming control circuit comprises: a controllable switch which is configured to be connected between terminals of the lamp receiving an alternating power supply voltage, and a switching control circuit operatively connected to the switch for controlling the opening and closing of the switch, the switching control circuit being configured to close the switch at least during a first closing time period and a subsequent second closing time period within a half period of the power supply voltage, wherein the second closing time period is longer than the first closing time period. The controllable switch may be a semiconductor switch element such as a transistor, e.g. a FET (Field Effect Transistor). The switching of a semiconductor switch element may be controlled by providing a suitable signal at a gate thereof. In a further embodiment, the switching control circuit is configured to close the switch during a plurality of closing time periods within a half period of the power supply voltage, each closing time period after the first closing time period being longer than a previous closing time period. The switching control circuit may comprise a programmed computer or controller having a memory and a processor to process computer instructions stored in the memory.

In an embodiment, the invention provides a dimming control circuit configured to start the first closing time period after a delay time period after a first reignition of the lamp after a voltage zero-crossing of the power supply voltage. A voltage zero-crossing sensing element or function provides a trigger signal which will activate a timer to count the delay time period. After the delay time period has passed, the first closing time period of the controllable switch will be started by the switching control circuit, as explained above.

In an embodiment, the invention provides a dimming control circuit, wherein the length of each closing time period is predetermined such that a reignition voltage of the lamp at the end of the closing time period does not exceed a first reignition voltage of the lamp after a voltage zero-crossing of the power supply voltage. The length of each closing time period may be programmed in the dimming control circuit or the switching control circuit. By keeping the reignition voltages low, the EMI produced by the dimming control circuit in operation is kept low.

In an embodiment, the invention provides a dimming control circuit, wherein the switching control circuit is configured to decrease the length of the closing time periods in a half period of the power supply voltage over a longer period of time comprising many periods of the mains voltage, as explained above.

In an embodiment, the invention provides a dimming control circuit, further comprising a receiver for receiving a dimming control signal indicative of a dimming level, the switching control circuit being configured to control the switch in accordance with the dimming level. The dimming control circuit may be designed to operate autonomously, and may additionally be operated in accordance with a dimming control signal received through a receiver, e.g. an RF (Radio Frequency) control signal or an IR (Infra Red) control signal sent wirelessly to an reception antenna coupled to the receiver. The dimming control signal may be used to set a specific dimming level of a gas discharge lamp connected to the dimming control circuit, or may be used to program the dimming control circuit or the switching control circuit by supplying instructions to have the dimming control circuit perform a specific dimming function.

In an embodiment of the invention, a dimming control circuit is used in dimming a fluorescent lamp.

In an embodiment, the invention provides a control module comprising a dimming control circuit, the control module having exterior dimensions corresponding to a conventional glowstarter. Since the dimming control method as implemented by the dimming control circuit produces low EMI, an electric filtering to reduce such EMI to an acceptable level requires only relatively small components. These small components may be built into a housing of a control module which may have the same or even smaller dimensions as a conventional glowstarter (usually a cylindrical housing having two terminals at one end of the housing). As a result, a conventional glowstarter may be replaced with the control module comprising a dimming control circuit according to the present invention.

Further features and characteristics of the present invention will be more readily appreciated from the following detailed description of non-limiting examples of embodiments taken in conjunction with the appended drawings.

### BRIEF DESCRIPTION OF THE DRAWINGS

FIG. 1 schematically depicts a lighting circuit comprising a dimming control circuit according to the present invention.

FIG. 2 schematically depicts a further light circuit comprising a dimming control circuit according to the present invention.

FIG. 3 schematically depicts a remote control circuit which may be used in an embodiment according to the present invention.

FIG. 4 schematically depicts an embodiment of a dimming control circuit according to the present invention.

FIG. 5 depicts diagrams of a lamp voltage and a lamp current produced by an embodiment of a dimming control method or a dimming control circuit according to the present invention.

FIG. 6 depicts diagrams of a lamp voltage, a lamp current and a dimming control signal produced by an embodiment of a dimming control method or a dimming control circuit according to the present invention.

In the different Figures, the same reference symbols indicate the same or similar components, or components have a similar function.

### DETAILED DESCRIPTION OF EXAMPLES

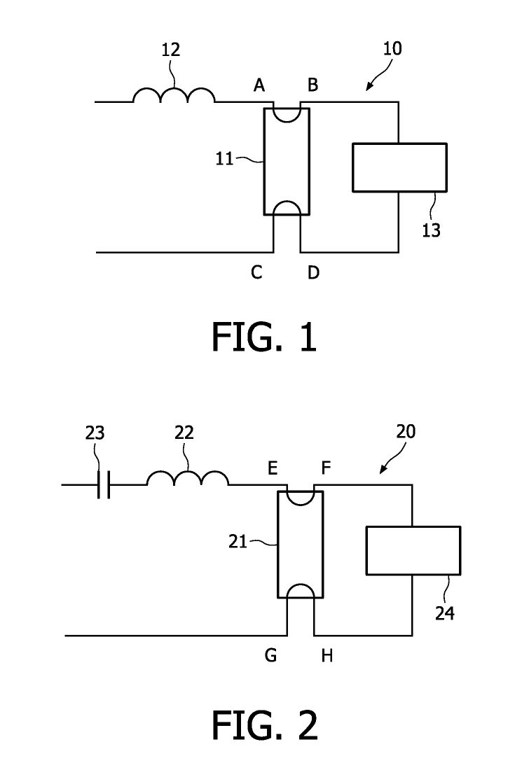

FIG. 1 depicts a lighting circuit 10 comprising a luminescent lamp 11 having four terminals A, B, C, and D. Terminal A of the lamp 11 is connected to a first terminal of an inductance 12. A second terminal of the inductance 12, and terminal C of the lamp 11 are adapted to be connected to a mains voltage, such as a 50 Hz or 60 Hz mains alternating voltage. Terminals B and D of the lamp 11 are connected to a dimming control circuit 13 to be explained in more detail below. The lighting circuit 10 has an inductive character.

FIG. 2 depicts a lighting circuit 20 comprising a luminescent lamp 21 having four terminals E, F, G and H. Terminal E of the lamp 21 is connected to a first terminal of a series connection of an inductance 22 and a capacitance 23. A second terminal of the series connection of the inductance 22 and the capacitance 23, and terminal G of the lamp 21 are adapted to be connected to a mains voltage, such as a 50 Hz or 60 Hz mains alternating voltage. Terminals F and H of the lamp 21 are connected to a dimming control circuit 24 to be explained in more detail below. The lighting circuit 20 has a capacitive character.

Apart from the capacitance 23, the lighting circuits 10 and 20 as shown in FIGS. 1 and 2, respectively, may be identical in whole or in part.

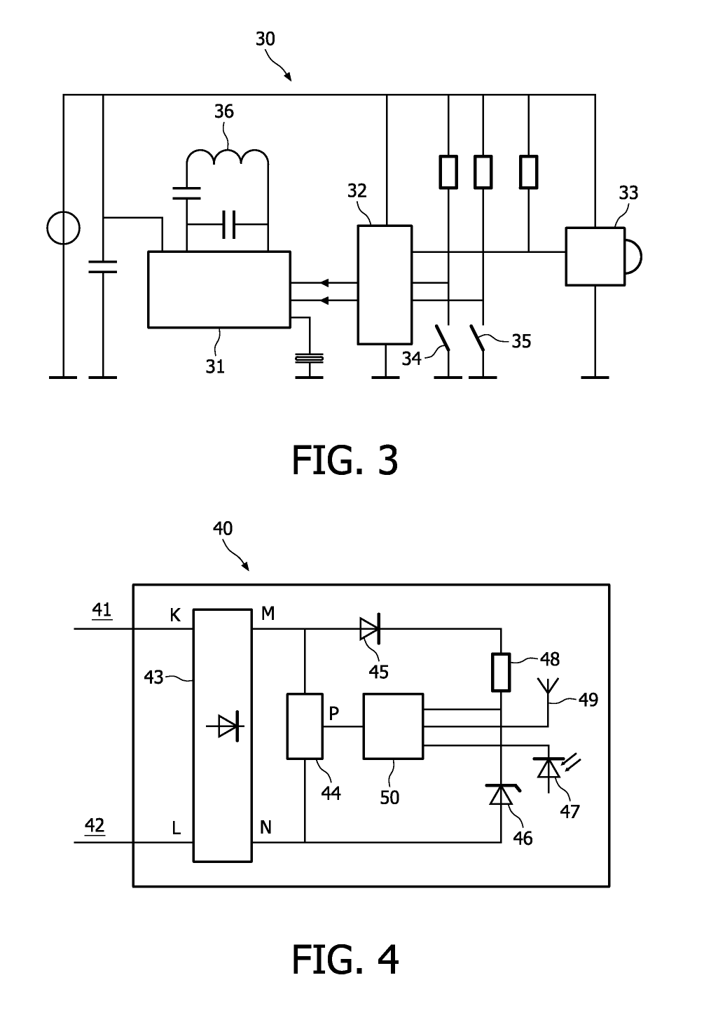

FIG. 3 depicts a remote control circuit 30 comprising a transmission/reception module 31, a processing module 32, and an IR (Infra Red) presence detection module 33. Also, two switches 34 and 35 are included.

The transmission/reception module 31 comprises an antenna 36 for transmission and/or reception of RF (Radio Frequency) signals to or from external devices or systems. As an example, the transmission/reception module 31 may transmit control signals to a dimming control circuit 13 or 24 as shown in FIGS. 1 and 2. Such control signals may instruct the dimming control circuit 13 or 24 to take a specific action, such as igniting the lamp 11 or 21, respectively, or dimming the lamp 11 or 21, or switching off the lamp 11 or 21. The transmission/reception module 31 may further receive control signals from a central or local lighting control system (not shown), e.g. in case of a building lighting management system. Such received control signals may instruct the remote control circuit 30 to generate a specific control signal for transmission, such as the transmitted control signals indicated above.

The presence detection module 33 is configured to detect infrared radiation emitted e.g. by living beings nearby.

The processing module 32 processes control signals and other signals input thereto by the transmission/reception module 31 and the presence detection module 33, as well as signals generated by closing and opening of the switches 34 and 35. The processing module 32 may provide power to the transmission/reception module 31. The processing module 32 may further, on the basis of the signals received, or on the basis of instructions programmed in a memory of the remote control circuit 30, generate and output control signals to the transmission/reception module 31 to be transmitted through the antenna 36, and destined for reception by e.g. the dimming control circuit 13 or 24, or a building lighting management system (not shown).

As an example, closing the switch 34 may instruct the processing module 32 to generate a control signal to be transmitted by the transmission/reception module 31 to be transmitted to instruct the dimming control circuit 13 or 24 to operate to turn on the lamp 11 or 21, respectively. Closing the switch 34 for more than a predetermined time period (e.g. one second) may result in an instruction to the control circuit 13 or 24 to operate to decrease the dimming of the lamp 11 or 21, respectively. Closing the switch 35 may instruct the processing module 32 to generate a control signal to be transmitted by the transmission/reception module 31 to be transmitted to instruct the dimming control circuit 13 or 24 to operate to turn off the lamp 11 or 21, respectively. Closing the switch 35 for more than a predetermined time period (e.g. one second) may result in an instruction to the dimming control circuit 13 or 24 to operate to increase the dimming of the lamp 11 or 21, respectively.

FIG. 4 shows a dimming control circuit 40 comprising terminals 41 and 42, rectifier circuit 43, switch 44, diode 45, Zener diode 46, radiation sensitive diode 47, resistor 48, and antenna 49, and control processor 50. The different components 43 to 50 may be enclosed in an enclosure 51 to form a control module.

The terminals 41 and 42, which may be the only elements extending from the enclosure 51 at the exterior thereof, are connected to input terminals K, L of the rectifier circuit 43, which may be e.g. embodied as a full bridge or half bridge rectifier circuit. Output terminals M and N of the rectifier circuit 43 are connected to the switch 44, which may either provide an open or a closed circuit. The switch 44 may be a switchable semiconductor element having a control terminal P at which a switching control signal may be input to determine the closed or open condition of the switch 44. The series connected diode 45, resistor 48, and Zener diode 46 are connected between terminals M and N. The control processor 50 is powered from a node between the resistor 48 and the Zener diode 46, and further connected to terminal N. The radiation sensitive diode 47 and the antenna 49 are connected to the control processor 50 to provide input signals thereto. The control processor 50 comprises a processor or computer system, at least one software application, and at least one memory for storing program instructions and data.

As already explained above in relation to FIG. 3, control signals may be transmitted e.g. by the remote control circuit 30 or other circuits like circuits being part of a building lighting management system. Such control signals may be received by the antenna 49 of the control circuit 40, to be processed by the control processor 50. Alternatively, or additionally, control signals may be received by the radiation sensitive diode 47 to be processed by the control processor 50. The control signals received by the antenna 49 or by the radiation sensitive diode 47 may instruct the control processor to provide a switching control signal to the switch 44 at its terminal P to open and close the switch 44 as determined by the control signals received, or on the basis of a set of data as stored in the control processor 50.

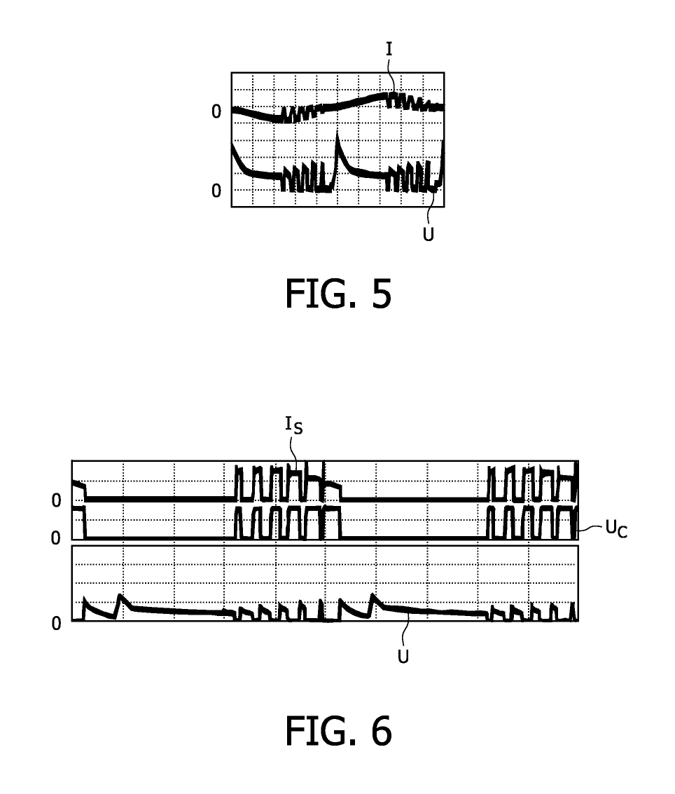

FIG. 5 illustrates an alternating current I through a gas discharge lamp and a corresponding voltage U (rectified) across the gas discharge lamp in an embodiment of the dimming control method of the present invention, with a horizontal time scale of 2 ms/div (i.e. a 50 Hz mains supply voltage). As can be seen in the graph of the current I, a switch in parallel with the gas discharge lamp (such as the switch 44 in FIG. 4) closes five times during a half period of the mains supply voltage. After the first closing time period, each successive time period has a longer time duration. The first closing time period comes after a delay time period after a zero-crossing of the mains voltage supply. At the left-hand side of FIG. 5, in the graph of the voltage U a first reignition voltage peak can be recognized. After about 5 ms after the first reignition peak, the switch closes during a first closing time period, and the voltage across the gas discharge lamp becomes zero. After the first closing time period, the switch opens again, and thereafter closes and opens four times again within the same half period of the voltage U. The time periods between the starting times of the closing time periods of the switch are substantially the same, whereas the closing time periods increase. It is to be noted that the time periods between the starting times of the closing time periods of the switch may also vary. It is further to be noted that the reignition voltage peak at the end of each closing time period is lower than the first reignition voltage peak at the left-hand side of FIG. 5, producing low EMI.

FIG. 6 illustrates a current I_{S} through a controllable switch, such as switch 44 in FIG. 4, connected in parallel to a gas discharge lamp and a corresponding voltage U (rectified) across the gas discharge lamp in an embodiment of the dimming control method of the present invention, with a horizontal time scale of 2 ms/div (i.e. a 50 Hz mains supply voltage). FIG. 6 further shows a dimming control signal U_{C} (such as a dimming control signal provided by control processor 50 to switch 44 at the terminal P thereof in FIG. 4) having a logical high value when the switch is closed (thereby short-circuiting the gas discharge lamp) and having a logical low value when the switch is open. As can be seen in the graph of the current I, a switch in parallel with the gas discharge lamp (such as the switch 44 in FIG. 4) closes six times during a half period of the mains supply voltage. After the first closing time period, each successive time period has a longer time duration. The first closing time period comes after a delay time period after a zero-crossing of the mains voltage supply. At the left-hand side of FIG. 6, in the graph of the voltage U a first reignition voltage peak (here: the second peak from the left) can be recognized. After about 4.3 ms after the first reignition peak, the switch closes during a first closing time period, and the voltage across the gas discharge lamp becomes zero. After the first closing time period, the switch opens again, and thereafter closes and opens five times again within the same half period of the voltage U. The time periods between the starting times of the closing time periods of the switch are substantially the same, whereas the closing time periods increase. It is to be noted that the time periods between the starting times of the closing time periods of the switch may also vary. It is further to be noted that the reignition voltage peak at the end of each closing time period (approximately indicated with a dashed line) is lower than the first reignition voltage peak at the left-hand side of FIG. 5, producing low EMI.

While the invention has been described and illustrated in its preferred embodiments, it should be understood that departures may be made therefrom within the scope of the invention, which is not limited to the details disclosed herein.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

1. Method of dimming a gas discharge lamp comprising:
providing a controllable switch connectable between terminals of the lamp receiving an alternating power supply voltage, and
controlling the opening and closing of the switch, the switch being closed at least during a first closing time period and a subsequent second closing time period within a half period of the power supply voltage, wherein the second closing time period is longer than the first closing time period.

2. Method according to claim 1, wherein the switch is closed during a plurality of closing time periods within a half period of the power supply voltage, each closing time period after the first closing time period being longer than a previous closing time period.

3. Method according to claim 1, wherein the first closing time period is started after a delay time period after a first reignition of the lamp after a voltage zero-crossing of the power supply voltage.

4. Method according to claim 3, wherein the delay time period is at least 20% of the half period of the power supply voltage.

5. Method according to claim 3, wherein the delay time period is at least 2 ms.

6. Method according to claim 1, wherein the length of the closing time periods in a half period of the power supply voltage is decreased over time.

7. Method according to claim 6, wherein length of the closing time periods in a half period of the power supply voltage is decreased over an expected life time of the lamp.

8. Dimming control circuit for a gas discharge lamp, the dimming control circuit comprising:
a controllable switch connectable between terminals of the lamp receiving an alternating power supply voltage, and
a switching control circuit operatively connected to the switch for controlling the opening and closing of the switch, the switching control circuit being configured to close the switch at least during a first closing time period and a subsequent second closing time period within a half period of the power supply voltage, wherein the second closing time period is longer than the first closing time period.

9. Dimming control circuit according to claim 8, wherein the switching control circuit is configured to close the switch during a plurality of closing time periods within a half period of the power supply voltage, each closing time period after the first closing time period being longer than a previous closing time period.

10. Dimming control circuit according to claim 8, wherein the switching control circuit is configured to start the first closing time period after a delay time period after a first reignition of the lamp after a voltage zero-crossing of the power supply voltage.

11. Dimming control circuit according to claim 8, wherein the length of each closing time period is predetermined such that a reignition voltage of the lamp at the end of the closing time period does not exceed a first reignition voltage of the lamp after a voltage zero-crossing of the power supply voltage.

12. Dimming control circuit according to claim 8, wherein the switching control circuit is configured to decrease the length of the closing time periods in a half period of the power supply voltage over time.

13. Dimming control circuit according to claim 8, further comprising a receiver for receiving a dimming control signal indicative of a dimming level, the switching control circuit being configured to control the switch in accordance with the dimming level.

14-15. (canceled)
